(19) United States
(12) Patent Application Publication
(10) Pub. No.: US 2026/0288120 A1
(43) Pub. Date: Sep. 24, 2026

(54) INTELLIGENT ROOT CAUSE ENGINE

(71) Applicant: Rockwell Automation Technologies, Inc., Mayfield Heights, OH (US)

(72) Inventors: Patrick E. Ozimek, Elm Grove, WI (US); Yuhong Huang, Acton, MA (US); Michael A. Spaner, Deep River, CT (US)

(21) Appl. No.: 19/085,784

(22) Filed: Mar. 20, 2025

(51) Int. Cl. G05B 19/418

(52) U.S. Cl. CPC G05B 19/4184; G05B 19/41885

(57) ABSTRACT

An industrial automation system includes one or more industrial automation devices and a control system, wherein the control system includes processing circuitry and a memory that may store instructions that, when executed by the processing circuitry, cause the processing circuitry to receive multiple input variables associated with one or more operations of the one or more industrial automation devices over a period of time, and receive fault data corresponding to the one or more industrial automation devices, identify at least one correlation between at least one input variable of the multiple input variables and the fault data, determine at least one weight for the at least one input variable based on the at least one correlation, and generate a model for identifying a root cause of a fault based on the plurality of input variables, the fault data, and the at least one weight.

### BACKGROUND

This disclosure generally relates to systems and methods for determining a root cause for a fault within an industrial automation system. More particularly, embodiments of the present disclosure are directed towards collecting operations data of an industrial automation device and identifying device inputs that may have contributed to the fault.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as admissions of prior art.

Industrial automation systems may include automation control and monitoring systems. The automation control and monitoring systems may monitor statuses and/or receive sensor data from a wide range of devices as they operate. At times, the devices within the industrial automation system may experience a fault, operate less efficiently, stop operating, or change its operation. When this occurs, as a portion of a troubleshooting process, the control and monitoring system may attempt to diagnose and determine a root cause of the fault experienced by the industrial automation device. However, as complexity (e.g., number of automation devices and/or amounts of sensor data) of an industrial automation system increases, a corresponding complexity of monitoring and/or diagnostics may also increase. As such, it may be beneficial to improve methods for analyzing and determining root causes of faults within an industrial automation system.

### SUMMARY

A summary of certain embodiments disclosed herein is set forth below. It should be understood that these aspects are presented merely to provide the reader with a brief summary of these certain embodiments and that these aspects are not intended to limit the scope of this present disclosure. Indeed, this present disclosure may encompass a variety of aspects that may not be set forth below.

In one embodiment, an industrial automation system includes one or more industrial automation devices and a control system, wherein the control system includes processing circuitry and a memory that may store instructions that, when executed by the processing circuitry, cause the processing circuitry to receive multiple input variables associated with one or more operations of the one or more industrial automation devices over a period of time, and receive fault data corresponding to the one or more industrial automation devices. The instructions also cause the processing circuitry to identify at least one correlation between at least one input variable of the multiple input variables and the fault data, determine at least one weight for the at least one input variable based on the at least one correlation, generate a model for identifying a root cause of a fault based on the plurality of input variables, the fault data, and the at least one weight, and adjust at least one data acquisition parameter for at least one sensor that may acquire at least one dataset associated with at least a second one of the plurality of input variables.

In another embodiment, a method includes receiving, via one or more processors of a control system, multiple input variables associated with one or more operations of one or more industrial automation devices over a period of time, receiving, via the one or more processors, fault data corresponding to the one or more industrial automation devices, and identifying, via the one or more processors, at least one correlation between at least one input variable of the multiple input variables and the fault data. The method also includes determining, via the one or more processors, at least one weight for the at least one input variable based on the at least one correlation, generating, via the one or more processors, a model for identifying a root cause of a fault based on the plurality of input variables, the fault data, and the at least one weight, and adjusting, via the one or more processors, at least one data acquisition parameter for at least one sensor that may acquire at least one dataset associated with at least a second one of the multiple input variables.

In yet another embodiment, a local control system of an industrial automation system includes a human machine interface (HMI), one or more industrial automation devices, and a device control system communicatively coupled to the HMI and the one or more industrial automation devices, wherein the device control system includes processing circuitry and a memory that may store instructions that, when executed by the processing circuitry, cause the processing circuitry to receive a plurality of input variables associated with one or more operations of the one or more industrial automation devices over a period of time and receive fault data corresponding to the one or more industrial automation devices. The instructions also cause the processing circuitry to identify at least one correlation between at least one input variable of the multiple input variables and the fault data, determine at least one weight for the at least one input variable based on the at least one correlation, generate a model for identifying a root cause of a fault based on the multiple input variables, the fault data, and the at least one weight, adjust at least one data acquisition parameter for at least one sensor that may acquire at least one dataset associated with at least a second one of the multiple input variables.

### BRIEF DESCRIPTION OF THE DRAWINGS

These and other features, aspects, and advantages of the present disclosure may become better understood when the following detailed description is read with reference to the accompanying drawings in which like characters represent like parts throughout the drawings, wherein:

FIG. 1 illustrates an example industrial automation system employed by a food manufacturer, in accordance with an embodiment;

FIG. 2 illustrates a diagrammatical representation of an exemplary local control system that may be employed in any suitable industrial automation system, in accordance with an embodiment;

FIG. 3 illustrates example components that may be part of an edge device of the local control system data, in accordance with an embodiment;

FIG. 4 illustrates a flow chart of a method for generating a model for root cause analysis, in accordance with an embodiment; and

FIG. 5 illustrates a flow chart of a method for determining a root cause of a fault and operational adjustments for a respective industrial automation device, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Present embodiments are directed towards a system and method for identifying potential root causes for a fault in an industrial automation system device. That is, as industrial automation devices within an industrial automation system operate, the devices may periodically operate less efficiently, stop operating, or change their operations at some instances. When the device experiences a fault or experiences a condition that otherwise forces the device to stop, an analysis of various datasets relating to the operations of the device in a time period leading up to the instance of the fault may provide useful information to help determine potential causes of the fault. In certain embodiments, several distinct inputs or variables may be related to or affect a single output variable, such as the occurrence of a fault, an anomaly or the like. Although each of these inputs may affect the output variable, one or more of the inputs may prove to be more closely linked with the output variable as compared to others.

With this in mind, in some embodiments, a device control system may monitor datasets to identify the root cause of a fault of a device and may dynamically tune or update the identified root cause based on the input variables that may have a greater weight on the effect to the output variable. By way of operations, the device control system may collect and store datasets that may include the input variables in a fixed buffer or storage component. After detecting a fault, the device control system may identify the input variables associated with the fault. Over time, the device control system may train a model based on this historical fault data, such that the model identifies potential causes to a detected fault based on correlations between different fault instances for the same fault and corresponding input variables. The model may determine weights associated with the different input variables based on the correlations to prioritize capturing certain types of data for detecting potential faults. In addition to correlation-based methods, present embodiments include causal discovery based methods to determine root cause relationships. Both human-guided and non-human guided causal discovery approaches may be used to determine true root cause relationships based on the observed data.

Keeping this in mind, certain computing and operational limitations may prevent the device control system from storing the datasets, including all of the input variables, collecting data a particular frequency or rate (e.g., above some threshold frequency), and the like. To this end, the device control system may prioritize the storage of particular input variables over others based on a respective weight associated with the respective input variable as indicated in the model. As such, the device control system may monitor a first input variable at a first frequency, while monitoring a second input variable at a lower frequency based on their respective weights with respect to a particular output variable. In certain embodiments, the device control system may store the relevant datasets in a circular buffer (e.g., first-in-first-out) to capture relevant data over a previous period of time. In this way, after detecting or receiving a notification indicative of a fault, the device control system may retrieve the data stored in the circular buffer and perform a root cause analysis on the respective datasets using the model to identify the root cause in an efficient manner while limiting the analysis of datasets that may be irrelevant or less impactful to the output variable.

In certain embodiments, the device control system may communicatively couple to an edge computing device (e.g., gateway, router, etc.) that may include data analysis containers operating on the edge computing device. The edge computing device may retrieve and analyze the collected data to determine a potential cause of the fault in accordance with the techniques described herein. By receiving the datasets that may be more closely associated with the respective fault or output variable, the device control system or other suitable device may identify the root cause and determine operational adjustments for the respective device more efficiently by processing or evaluating a subset of data related to the fault, as opposed to a larger dataset that may include irrelevant or less impactful data.

Additionally, in some embodiments, the device control system may employ artificial intelligence (AI) algorithms to dynamically adjust the datasets being monitored, the frequencies in which each dataset may be monitored, and the like based on expected faults, changes in weights, and the like. For example, the device control system may receive a notification or update from other systems that may indicate a change in weight for a particular input variable, a change in priority of output variables (e.g., types of faults) that may be expected for a particular device, or the like. The notification may be generated based on an AI analysis of a collection of datasets from various devices across a region or area over some period of time. Based on the notification, the device control system may adjust the monitoring operations of the respective datasets to capture the datasets that may be more relevant to the operation of the respective device in view of the AI findings. In this way, the device control system may continuously evaluate and dynamically monitor data that may be more likely to provide insight into the occurrence or root cause of a fault.

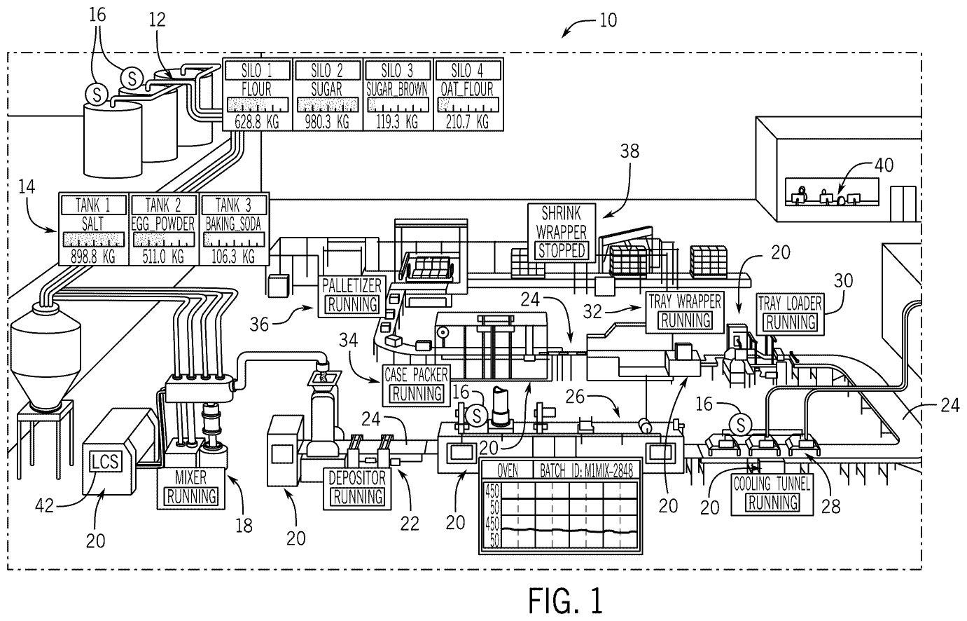

By way of introduction, FIG. 1 illustrates an example industrial automation system 10 employed by a food manufacturer. It should be noted that although the example industrial automation system 10 of FIG. 1 is directed at a food manufacturer, the present embodiments described herein may be employed within any suitable industry, such as automotive, mining, hydrocarbon production, manufacturing, and the like. The following brief description of the example industrial automation system 10 employed by the food manufacturer is provided herein to help facilitate a more comprehensive understanding of how the embodiments described herein may be applied to industrial devices to significantly improve the operations of the respective industrial automation system. As such, the embodiments described herein should not be limited to be applied to the example depicted in FIG. 1.

Referring now to FIG. 1, the example industrial automation system 10 for a food manufacturer may include silos 12 and tanks 14. The silos 12 and the tanks 14 may store different types of raw material, such as grains, salt, yeast, sweeteners, flavoring agents, coloring agents, vitamins, minerals, and preservatives. In some embodiments, sensors 16 may be positioned within or around the silos 12, the tanks 14, or other suitable locations within the industrial automation system 10 to measure certain properties, such as temperature, mass, volume, pressure, humidity, and the like.

The raw materials may be provided to a mixer 18, which may mix the raw materials together according to a specified ratio. The mixer 18 and other machines in the industrial automation system 10 may employ certain industrial automation devices 20 to control the operations of the mixer 18 and other machines. The industrial automation devices 20 may include controllers, input/output (I/O) modules, motor control centers, motors, human machine interfaces (HMIs), operator interfaces, contactors, starters, sensors 16, actuators, conveyors, drives, relays, protection devices, switchgear, compressors, sensor, actuator, firewall, network switches (e.g., Ethernet switches, modular-managed, fixed-managed, service-router, industrial, unmanaged, etc.) and the like.

The mixer 18 may provide a mixed compound to a depositor 22, which may deposit a certain amount of the mixed compound onto a conveyor 24. The depositor 22 may deposit the mixed compound on the conveyor 24 according to a shape and amount that may be specified to a control system for the depositor 22. The conveyor 24 may be any suitable conveyor system that transports items to various types of machinery across the industrial automation system 10. For example, the conveyor 24 may transport deposited material from the depositor 22 to an oven 26, which may bake the deposited material. The baked material may be transported to a cooling tunnel 28 to cool the baked material, such that the cooled material may be transported to a tray loader 30 via the conveyor 24. The tray loader 30 may include machinery that receives a certain amount of the cooled material for packaging. By way of example, the tray loader 30 may receive 25 ounces of the cooled material, which may correspond to an amount of cereal provided in a cereal box.

A tray wrapper 32 may receive a collected amount of cooled material from the tray loader 30 into a bag, which may be sealed. The tray wrapper 32 may receive the collected amount of cooled material in a bag and seal the bag using appropriate machinery. The conveyor 24 may transport the bagged material to a case packer 34, which may package the bagged material into a box. The boxes may be transported to a palletizer 36, which may stack a certain number of boxes on a pallet that may be lifted using a forklift or the like. The stacked boxes may then be transported to a shrink wrapper 38, which may wrap the stacked boxes with shrink-wrap to keep the stacked boxes together while on the pallet. The shrink-wrapped boxes may then be transported to storage or the like via a forklift or other suitable transport vehicle.

To perform the operations of each of the devices in the example industrial automation system 10, the industrial automation devices 20 may be used to provide power to the machinery used to perform certain tasks, provide protection to the machinery from electrical surges, prevent injuries from occurring with human operators in the industrial automation system 10, monitor the operations of the respective device, communicate data regarding the respective device to a supervisory control system 40, and the like. In certain embodiments, the supervisory control system 40 may receive data relating to one or more inputs received by a respective device during operation, and in other embodiments, may receive data relating to one or more outputs of the respective device during operation. In some embodiments, each industrial automation device 20 or a group of industrial automation devices 20 may be controlled using a local control system 42. That is, the local control system 42 may receive data relating to one or more inputs received by a respective device during operation, and in other embodiments, may receive data relating to one or more outputs of the respective device during operation. In any case, the data may include datasets that correspond to the operation of the respective industrial automation device 20, other industrial automation devices 20, user inputs, other suitable inputs to control the operations of the respective industrial automation device(s) 20, and outputs of the respective industrial automation device 20 during operation.

In some cases, an industrial automation device 20 may periodically experience a fault (e.g., operate less efficiently, stop operating, or change its operation at some instances). When the industrial automation device 20 experiences the fault or experiences a condition that otherwise may force the industrial automation device 20 to stop, the supervisory control system 40 and/or the local control system 42 may analyze the datasets regarding the operation of the industrial automation device 20. That is, the supervisory control system 40 and/or the local control system 42 may analyze datasets that generally correspond to inputs that control the operations of the respective industrial automation device 20 during a time period leading up to the instance of the fault, datasets that include measurements of variables detected from sensors and the like, datasets interpolated by other computing devices, and the like. By performing this analysis, the supervisory control system 40 and/or the local control system 42 may determine potential causes of the fault based on changes within the datasets during a time period prior to the detected fault. In certain embodiments, the supervisory control system 40 and/or the local control system 42 may determine that one or more of the parameters of the datasets may be more closely linked or correlated with an output variable than one or more of the remaining inputs. As discussed in further detail below, the supervisory control system 40 and/or the local control system 42 may, as a result of the aforementioned analysis, provide weights to the one or more inputs to the respective industrial automation device 20.

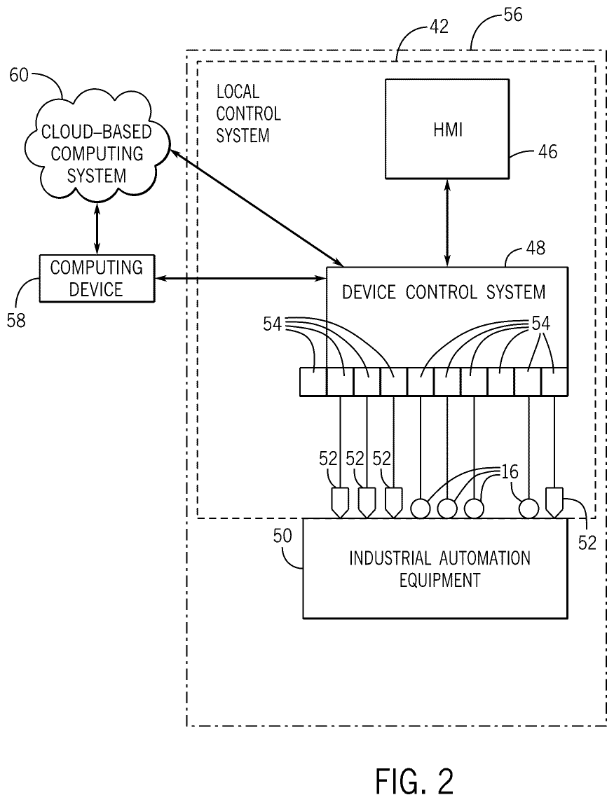

To illustrate certain embodiments in which the local control system 42 may be communicatively coupled to other devices, FIG. 2 illustrates a diagrammatical representation of an embodiment of the local control system 42 that may be employed in any suitable industrial automation system 10, in accordance with embodiments presented herein. In FIG. 2, the local control system 42 is illustrated as including a human machine interface (HMI) 46 and a device control system 48 or automation controller adapted to interface with devices that may monitor and control various types of industrial automation equipment 50. By way of example, the industrial automation equipment 50 may include the mixer 18, the depositor 22, the conveyor 24, the oven 26, and the other pieces of machinery described in FIG. 1.

It should be noted that the HMI 46 and the device control system 48, in accordance with embodiments of the present techniques, may be facilitated by the use of certain network strategies. Indeed, an industry standard network may be employed, such as DeviceNet, to enable data transfer. Such networks permit the exchange of data in accordance with a predefined protocol and may provide power for operation of networked elements.

As discussed above, the industrial automation equipment 50 may take many forms and include devices for accomplishing many different and varied purposes. For example, the industrial automation equipment 50 may include machinery used to perform various operations in a compressor station, an oil refinery, a batch operation for making food items, a mechanized assembly line, and so forth. Accordingly, the industrial automation equipment 50 may include a variety of operational components, such as electric motors, valves, actuators, temperature elements, pressure sensors, or a myriad of machinery or devices used for manufacturing, processing, material handling, and other applications.

Additionally, the industrial automation equipment 50 may include various types of equipment that may be used to perform the various operations that may be part of an industrial application. For instance, the industrial automation equipment 50 may include electrical equipment, hydraulic equipment, compressed air equipment, steam equipment, mechanical tools, protective equipment, refrigeration equipment, power lines, hydraulic lines, steam lines, and the like. Some example types of equipment may include mixers, machine conveyors, tanks, skids, specialized original equipment manufacturer machines, and the like. In addition to the equipment described above, the industrial automation equipment 50 may be made up of certain automation devices 20, which may include controllers, input/output (I/O) modules, motor control centers, motors, human machine interfaces (HMIs), operator interfaces, contactors, starters, sensors 16, actuators, drives, relays, protection devices, switchgear, compressors, firewall, network switches (e.g., Ethernet switches, modular-managed, fixed-managed, service-router, industrial, unmanaged, etc.) and the like.

In certain embodiments, one or more properties of the industrial automation equipment 50 may be monitored and controlled by certain equipment for regulating control variables used to operate the industrial automation equipment 50. For example, the sensors 16 may monitor various properties of the industrial automation equipment 50 and actuators 52 may adjust operations of the industrial automation equipment 50, respectively. In some cases, the adjusted operations may be put into place in response to the industrial automation equipment experiencing a fault or otherwise encounter a stop in operations. In some embodiments, the device control system 48 may output a command to adjust one or more operations of the industrial automation equipment 50 or the industrial automation device 20 in response to results from a root cause analysis that was conducted after detecting the fault.

In some cases, the industrial automation equipment 50 may be associated with devices used by other equipment. For instance, scanners, gauges, valves, flow meters, and the like may be disposed on industrial automation equipment 50. Here, the industrial automation equipment 50 may receive data from the associated devices and use the data to perform their respective operations more efficiently. For example, a controller (e.g., device control system 48) of a motor drive may receive data regarding a temperature of a connected motor and may adjust operations of the motor drive based on the data. To further build off the example above, if the temperature of the connected motor rises above a threshold temperature (e.g., 250° F., 300° F., 400° F., 500° F., etc.), the device control system 48 may output a command to reduce a rotational speed of the motor, reduce a rotational torque output of the motor, or otherwise stop the motor. In other embodiments, the device control system 48 may receive and store a dataset corresponding to the temperature of the connected motor that may be retrieved for a subsequent root cause analysis.

In certain embodiments, the industrial automation equipment 50 may include a communication component that enables the industrial automation equipment 50 to communicate data between each other and other devices. The communication component may include a network interface that may enable the industrial automation equipment 50 to communicate via various protocols such as Ethernet/IP®, ControlNet®, DeviceNet®, or any other industrial communication network protocol. Alternatively, the communication component may enable the industrial automation equipment 50 to communicate via various wired or wireless communication protocols, such as Wi-Fi, mobile telecommunications technology (e.g., 2G, 3G, 4G, 5G, LTE), Bluetooth®, near-field communications technology, and the like.

The sensors 16 may be any number of devices adapted to provide information regarding process conditions. The actuators 52 may include any number of devices adapted to perform a mechanical action in response to a signal from a controller (e.g., the device control system 48). The sensors 16 and actuators 52 may be utilized to operate the industrial automation equipment 50. Indeed, they may be utilized within process loops that are monitored and controlled by the device control system 48 and/or the HMI 46. Such a process loop may be activated based on process inputs (e.g., input from a sensor 16) or direct operator input received through the HMI 46. As illustrated, the sensors 16 and actuators 52 are in communication with the device control system 48. Further, the sensors 16 and actuators 52 may be assigned a particular address in the device control system 48 and receive power from the device control system 48 or attached modules.

Input/output (I/O) modules 54 may be added or removed from the local control system 42 via expansion slots, bays or other suitable mechanisms. In certain embodiments, the I/O modules 54 may be included to add functionality to the device control system 48, or to accommodate additional process features. For instance, the I/O modules 54 may communicate with new sensors 16 or actuators 52 added to monitor and control the industrial automation equipment 50. It should be noted that the I/O modules 54 may communicate directly to sensors 16 or actuators 52 through hardwired connections or may communicate through wired or wireless sensor networks, such as Hart or IOLink.

Generally, the I/O modules 54 serve as an electrical interface to the device control system 48 and may be located proximate or remote from the device control system 48, including remote network interfaces to associated systems. In such embodiments, data may be communicated with remote modules over a common communication link, or network, wherein modules on the network communicate via a standard communications protocol. Many industrial controllers can communicate via network technologies such as Ethernet (e.g., IEEE802.3, TCP/IP, UDP, Ethernet/IP, and so forth), ControlNet, DeviceNet or other network protocols (Foundation Fieldbus (H1 and Fast Ethernet) Modbus TCP, Profibus) and also communicate to higher level computing systems.

In the illustrated embodiment, several of the I/O modules 54 may transfer input and output signals between the device control system 48 and the industrial automation equipment 50. As illustrated, the sensors 16 and actuators 52 may communicate with the device control system 48 via one or more of the I/O modules 54 coupled to the device control system 48. Additionally or alternatively, the device control system 48 may convert the input and output signals into a machine-readable dataset that may be stored and retrieved at a later time. For example, an input signal output from an I/O module 54 to an actuator 52 configured to cause a motor coupled to the industrial automation equipment 50 to rotate may be received by the device control system 48 and converted into a dataset, and the dataset may be saved in a memory of the device control system 48. As discussed in further detail below, the device control system 48 may retrieve this saved machine-readable dataset for analysis at a later time.

In certain embodiments, the local control system 42 (e.g., the HMI 46, the device control system 48, the sensors 16, the actuators 52, the I/O modules 54) and the industrial automation equipment 50 may make up an industrial automation application 56. The industrial automation application 56 may involve any type of industrial process or system used to manufacture, produce, process, or package various types of items. For example, the industrial automation application 56 may include industries such as material handling, packaging industries, manufacturing, processing, batch processing, the example industrial automation system 10 of FIG. 1, and the like.

In certain embodiments, the device control system 48 may be communicatively coupled to an edge computing device 58 and a cloud-based computing system 60. In this network, input and output signals generated from the device control system 48 may be communicated between the edge computing device 58 and the cloud-based computing system 60. Although the device control system 48 may be capable of communicating with the edge computing device 58 and the cloud-based computing system 60, as mentioned above, in certain embodiments, the device control system 48 (e.g., local control system 42) may perform certain operations and analysis without sending data to the edge computing device 58 or the cloud-based computing system 60.

In some embodiments, the edge computing device 58 may include data analysis containers that operate on the edge computing device 58. For example, the data analysis containers may receive input and output signals that may include one or more datasets corresponding to one or more input variables and an output variable for an industrial automation device 20. In this way, the edge computing device 58 may, based on the received input and output signals, initiate a root cause analysis of a fault experienced during an operation of the industrial automation device 20. In certain embodiments, the edge computing device 58 may identify the root cause and determine operational adjustments for the respective industrial automation device 20 more efficiently by processing or evaluating a subset of the received datasets, as opposed to a larger dataset that may include irrelevant or less impactful data.

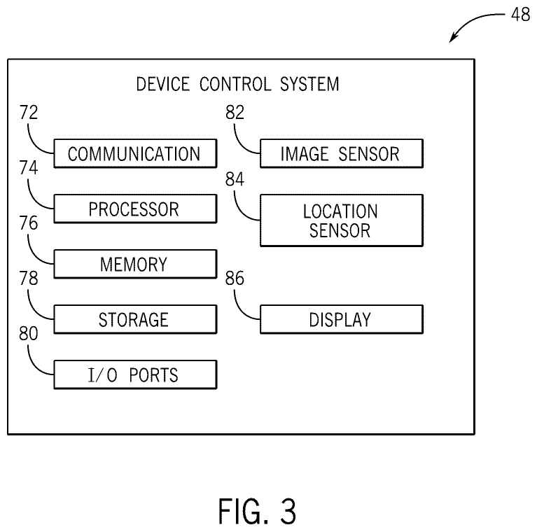

In any case, FIG. 3 illustrates example components that may be part of the device control system 48, in accordance with embodiments presented herein. For example, the device control system 48 may include a communication component 72, a processor 74, a memory 76, a storage 78, input/output (I/O) ports 80, an image sensor 82 (e.g., a camera), a location sensor 84, a display 86, additional sensors (e.g., vibration sensors, temperature sensors), and the like. The communication component 72 may be a wireless or wired communication component that may facilitate communication between the industrial automation equipment 50, the cloud-based computing system 60, and other communication capable devices.

The processor 74 may be any type of computer processor or microprocessor capable of executing computer-executable code. The processor 74 may also include multiple processors that may perform the operations described below. The memory 76 and the storage 78 may be any suitable articles of manufacture that can serve as media to store processor-executable code, data, or the like. These articles of manufacture may represent computer-readable media (e.g., any suitable form of memory or storage) that may store the processor-executable code used by the processor 74 to perform the presently disclosed techniques. Generally, the processor 74 may execute software applications that include programs that enable a user to track and/or monitor operations of the industrial automation equipment 50 via a local or remote communication link. That is, the software applications may communicate with the device control system 48 and gather information associated with the industrial automation equipment 50 as determined by the device control system 48, via the sensors 16 disposed on the industrial automation equipment 50 and the like.

The memory 76 and the storage 78 may also be used to store the data, analysis of the data, the software applications, and the like. For example, the memory 76 and the storage 78 may store datasets relating to the operation of a respective industrial automation device 20. That is, the datasets may include input variables and/or output variables that correspond to the operation of the respective industrial automation device 20. In some embodiments, the storage 78 may store the datasets on a fixed buffer or otherwise suitable storage component. In other embodiments, the storage 78 may store the datasets in a circular buffer (e.g., first dataset in-first dataset out) to capture relevant datasets over a previous period of time. In some embodiments, the circular buffer may store a dataset over 10 seconds, 60 seconds, 2 minutes, 5 minutes, 15 minutes, 3 hours, 2 days, or any otherwise appropriate duration. For example, if a determination is made that a first input variable is closely related to an industrial automation device experiencing a fault, then the device control system 48 may store the first input variable in a circular buffer with an increased frequency to ensure that a sufficient amount of data related to the first input variable may be available for analysis. Additionally or alternatively, if the device control system 48 determines that the first input variable is less correlated to the presence of a fault, the device control system 48 may store the datasets related to the first input variable with a lower frequency than previously used to preserve more of the circular buffer to store data related to other input variables that may be more relevant to other faults.

In addition to a specified duration that the memory 76 and storage 78 may store the multiple datasets, the device control system 48 may output a control signal to store a particular input variable dataset at an increased frequency (e.g., above a threshold frequency). For example, to follow up on the example from above, if the first input variable is determined to be closely linked to an industrial automation device 20 experiencing a fault, the first input signal corresponding to the first input variable may be recorded at a high frequency (e.g., one reading every second, 5 readings per second, 30 readings per second, etc.) as compared to other input variables. Relatedly, if a determination is made by the device control system 48 that a particular input variable, different from the first input variable, is not closely linked to the industrial automation device 20 experiencing a fault, then the device control system 48 may store an input signal corresponding to the particular input variable at a lower frequency, below a certain frequency threshold (e.g., one reading per minute, one reading every five minutes, a reading once an hour, etc.). To achieve this, the device control system 48 may assign a first weight to a first input variable and a second weight to a second input variable, such that the first weight is higher than the second weight. In some embodiments, the higher weight associated with the first input variable may indicate to the local control system 42 that the first input variable may be stored at a rate exceeding the frequency threshold, while the second input variable may be stored at a rate below the frequency threshold. In this way, the device control system 48 may prioritize the storage of particular input variables over others based on a respective weight associated with the respective input variable.

The memory 76 and the storage 78 may represent non-transitory computer-readable media (e.g., any suitable form of memory or storage) that may store the processor-executable code used by the processor 74 to perform various techniques described herein. It should be noted that non-transitory merely indicates that the media is tangible and not a signal.

In one embodiment, the memory 76 and/or storage 78 may include a software application that may be executed by the processor 74 and may be used to monitor, control, access, or view one of the industrial automation equipment 50. As such, the edge computing device 58 may communicatively couple to industrial automation equipment 50 or to a respective computing device of the industrial automation equipment 50 via a direct connection between the devices or via the cloud-based computing system 60. The software application may perform various functionalities, such as track statistics of the industrial automation equipment 50, store reasons for placing the industrial automation equipment 50 offline, determine reasons for placing the industrial automation equipment 50 offline, secure industrial automation equipment 50 that is offline, deny access to place an offline industrial automation equipment 50 back online until certain conditions are met, and so forth.

The I/O ports 80 may be interfaces that may couple to other peripheral components such as input devices (e.g., keyboard, mouse), sensors, input/output (I/O) modules 54, and the like. I/O modules 54 may enable the edge computing device 58 or other device control systems 48 to communicate with the industrial automation equipment 50 or other devices in the industrial automation system via the I/O modules 54.

The image sensor 82 may include any image acquisition circuitry such as a digital camera capable of acquiring digital images, digital videos, or the like. The location sensor 84 may include circuitry designed to determine a physical location of the device control system 48. In one embodiment, the location sensor 84 may include a global positioning system (GPS) sensor that acquires GPS coordinates for the device control system 48.

The display 86 may depict visualizations associated with software or executable code being processed by the processor 74. In one embodiment, the display 86 may be a touch display capable of receiving inputs (e.g., parameter data for operating the industrial automation equipment 50) from a user of the device control system 48. As such, the display 86 may serve as a user interface to communicate with the industrial automation equipment 50. The display 86 may be used to display a graphical user interface (GUI) for operating the industrial automation equipment 50, for tracking the maintenance of the industrial automation equipment 50, and the like. The display 86 may be any suitable type of display, such as a liquid crystal display (LCD), plasma display, or an organic light emitting diode (OLED) display, for example. Additionally, in one embodiment, the display 86 may be provided in conjunction with a touch-sensitive mechanism (e.g., a touch screen) that may function as part of a control interface for the industrial automation equipment 50 or for a number of pieces of industrial automation equipment in the industrial automation application 56, to control the general operations of the industrial automation application 56. In some embodiments, the operator interface may be characterized as the HMI 46, a human-interface machine, or the like.

In a non-limiting embodiment, the display 86 may depict a visualization of a notification indicative of a fault experienced by an industrial automation device 20 or by the industrial automation equipment 50. The notification may indicate a component of the device or equipment that experienced the fault, a time of the fault, or otherwise useful information that may be utilized to resolve the fault. Additionally or alternatively, the device control system 48, upon receiving the notification, may retrieve one or more of the datasets stored in the circular buffer and perform a root cause analysis on the respective datasets to identify the root cause of the fault. In this way, based on the weights assigned to the respective input variables, the root cause analysis may be completed in an efficient manner, as the device control system 48 may not review or analyze datasets deemed irrelevant to an output (e.g., the fault) of the industrial automation device 20 or the industrial automation equipment 50.

Although the components described above have been discussed with regard to the device control system 48, it should be noted that similar components may make up other computing devices described herein. Further, it should be noted that the listed components are provided as example components and the embodiments described herein are not to be limited to the components described with reference to FIG. 3.

Referring back to FIG. 2, in operation, the industrial automation application 56 may receive one or more inputs used to produce one or more outputs. For example, the inputs may include feedstock, electrical energy, fuel, parts, assemblies, sub-assemblies, operational parameters (e.g., sensor measurements), or any combination thereof. Additionally, the outputs may include finished products, semi-finished products, assemblies, manufacturing products, by products, or any combination thereof.

To produce the one or more outputs, the device control system 48 may control operation of the industrial automation application 56. In some embodiments, the device control system 48 may control operation by outputting control signals to instruct industrial automation equipment 50 to perform a control action by implementing manipulated variable set points. For example, the device control system 48 may instruct a motor (e.g., an automation device 20) to implement a control action by actuating at a particular speed (e.g., a manipulated variable set point).

In some embodiments, the device control system 48 may determine the manipulated variable set points based at least in part on process data. As described above, the process data may be indicative of operation of the industrial automation device 20, the industrial automation equipment 50, the industrial automation application 56, and the like. As such, the process data may include operational parameters of the industrial automation device 20 and/or operational parameters of the industrial automation application 56. For example, the operational parameters may include any suitable type, such as temperature, flow rate, electrical power, and the like.

Thus, the device control system 48 may receive process data from one or more of the industrial automation devices 20, the sensors 16, or the like. In some embodiments, the sensor 16 may determine an operational parameter and communicate a measurement signal indicating the operational parameter to the device control system 48. For example, a temperature sensor may measure a temperature of a motor (e.g., an automation device 20) and transmit a measurement signal indicating the measured temperature to the device control system 48. The device control system 48 may then analyze the process data to monitor performance of the industrial automation application 56 (e.g., determine an expected operational state) and/or perform diagnostics on the industrial automation application 56.

To facilitate controlling operation and/or performing other functions, the device control system 48 may include one or more controllers, such as one or more model predictive control (MPC) controllers, one or more proportional-integral-derivative (PID) controllers, one or more neural network controllers, one or more fuzzy logic controllers, or any combination thereof.

In some embodiments, the supervisory control system 40 may provide centralized control over operation of the industrial automation application 56. For example, the supervisory control system 40 may enable centralized communication with a user (e.g., operator). To facilitate, the supervisory control system 40 may include the display 86 to facilitate providing information to the user. For example, the display 86 may display visual representations of information, such as process data, selected features, expected operational parameters, and/or relationships there between. Additionally, the supervisory control system 40 may include similar components as the device control system 48 described above in FIG. 3.

On the other hand, the device control system 48 may provide localized control over a portion of the industrial automation application 56 via the local control system 42. For example, in the depicted embodiment of FIG. 1, the local control system 42 that may be part of the mixer 18 may provide control over operation of a first automation device 20 that controls the mixer 18, and a second local control system 42 may provide control over operation of a second automation device 20 that controls the operation of the depositor 22.

In some embodiments, the local control system 42 may control operation of a portion of the industrial automation application 56 based at least in part on the control strategy determined by the supervisory control system 40. Additionally, the supervisory control system 40 may determine the control strategy based at least in part on process data determined by the local control system 42. Thus, to implement the control strategy, the supervisory control system 40 and the local control systems 42 may be communicatively coupled via a network, which may be any suitable type, such as an Ethernet/IP network, a ControlNet network, a DeviceNet network, a Data Highway Plus network, a Remote I/O network, a Foundation Fieldbus network, a Serial, DH-485 network, a SynchLink network, or any combination thereof.

Some analysis processes (e.g., identifying a root cause for a fault, determining an input variable more closely linked to the fault, etc.) described above may be performed by machine learning circuitry using the one or more input variable datasets and the output of the industrial automation device 20. The machine learning circuitry (e.g., circuitry used to implement machine learning algorithms or logic) may access the one or more input variable datasets and the output of the industrial automation device 20 to identify patterns, correlations, or trends associated with the data. As a result, new data patterns not previously attainable without machine learning based on the one or more input variable datasets may emerge. As used herein, machine learning may refer to algorithms and statistical models that computer systems use to perform a specific task with or without using explicit instructions. For example, a machine learning process may generate a mathematical model based on a sample of the clean data, known as “training data,” in order to make predictions or decisions without being explicitly programmed to perform the task.

Depending on the inferences to be made, the machine learning circuitry may implement different forms of machine learning. In some embodiments, a supervised machine learning may be implemented. In supervised machine learning, the mathematical model of a set of transaction data contains both the inputs and the desired outputs. The set of transaction data is referred to as “training data” and is essentially a set of training examples. Each training example has one or more inputs and the desired output, also known as a supervisory signal. In a mathematical model, each training example is represented by an array or vector, sometimes called a feature vector, and the training data is represented by a matrix. Through iterative optimization of an objective function, supervised learning algorithms learn a function that can be used to predict the output associated with new inputs. An optimal function will allow the algorithm to correctly determine the output for inputs that were not a part of the training data. An algorithm that improves the accuracy of its outputs or predictions over time is said to have learned to perform that task.

Supervised learning algorithms may include classification and regression. Classification algorithms are used when the outputs are restricted to a limited set of values, and regression algorithms are used when the outputs may have any numerical value within a range. Similarity learning is an area of supervised machine learning closely related to regression and classification, but the goal is to learn from examples using a similarity function that measures how similar or related two occurrences (e.g. a drive motor beginning to increase a rotational speed increase and a fault for the respective industrial automation device 20) are.

Additionally and/or alternatively, in some situations, it may be beneficial for the machine-learning circuitry to utilize unsupervised learning (e.g., when particular output types are not known). Unsupervised learning algorithms take a set of transaction data that contains only inputs, and find structure in the data, like grouping or clustering of transaction data. The algorithms, therefore, learn from test data that has not been labeled, classified or categorized. Instead of responding to feedback, unsupervised learning algorithms identify commonalities in the one or more input variable datasets and react based on the presence or absence of such commonalities in each new piece of output variable data.

Cluster analysis is the assignment of a set of observations (e.g., operational characteristics of the industrial automation equipment 50) into subsets (called clusters) so that observations within the same cluster are similar according to one or more predesignated criteria, while observations drawn from different clusters are dissimilar. Different clustering techniques make different assumptions on the structure of the datasets of the input variables, often defined by some similarity metric and evaluated, for example, by internal compactness, the similarity between clusters, and separation, the difference between clusters. Predictions or correlations may be derived by the machine learning circuitry. For example, groupings and/or other classifications of the one or more input variable datasets and output variable dataset may be used to identify potential root causes of a fault within the industrial automation system 10. In certain embodiments, a user may label an identified cluster with their determination of a root cause of a particular fault experienced within the industrial automation system 10. In this case, the labeled cluster and it's associated root cause determination may be included with the “training data.” In other embodiments, these user-labeled clusters may be included as part of the training examples to train the model in an offline state. The predictions may be provided to downstream applications, including the local control system 42, the device control system 48, or the industrial automation application 56 which may perform actions based upon the predictions.

It should be appreciated that the described embodiment of the local control system 42 is merely intended to be illustrative and not limiting. The local control system 42 may include one or more components of the device control system 48. In some cases, the device control system 48 may be one component of the local control system 42. That is, the device control system 48 may be part of a collection of modules.

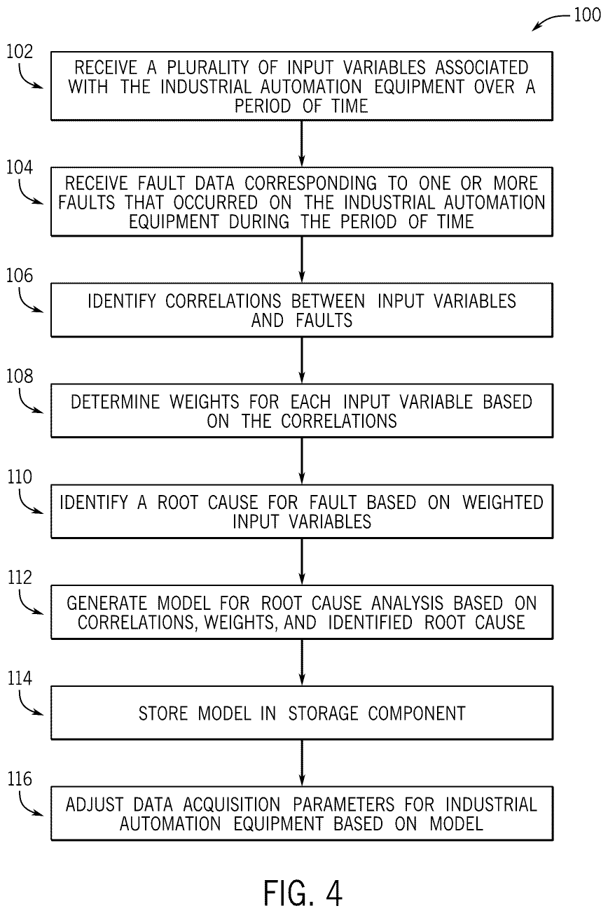

FIG. 4 illustrates an embodiment of a flow chart of a process 100 for generating a model for identifying potential causes to a detected fault and facilitating a root cause analysis to determine a cause of a particular fault experienced by a device within an industrial automation system 10. Although the following description of the process 100 will be described as being performed by the device control system 48, it should be noted that any suitable processor-based device (e.g., the edge computing device 58, the local control system 42, etc.) may be specially programmed to perform any of the processes described herein. Moreover, although the following description of the process 100 is described as including certain steps performed in a particular order, it should be understood that the steps of the process 100 may be performed in any suitable order, that certain steps may be omitted, that certain steps may be added, and/or that certain steps may be performed simultaneously.

At block 102, the device control system 48 may receive multiple input variables associated with the industrial automation equipment 50 over a period of time. That is, the device control system 48 may receive multiple input variable signals from one or more sensors 16 that correspond with various operational parameters (e.g., temperature, flow rate, electrical power, etc.) during operation of the industrial automation equipment 50. In some embodiments, the operational parameters may be associated with various industrial automation devices 20 that operate as a portion of an operation associated with the industrial automation equipment 50. The device control system 48 may receive and store the multiple input variable signals in the memory 76 and/or storage 78 of the device control system 48.

At block 104, the device control system 48 may receive fault data corresponding to one or more faults that may occur on the industrial automation equipment 50 during the period of time. That is, the device control system 48 may receive multiple output variable signals from one or more sensors 16 that correspond with various operational outputs of the industrial automation equipment 50. For example, when the industrial automation equipment 50 experiences a fault, the equipment may operate less efficiently, stop operating, or change its operations. In some cases, when the industrial automation equipment 50 experiences a fault, the device control system 48 may receive associated information relating to the fault. For example, the device control system 48 may receive a time that the fault occurred. In other embodiments, the device control system 48 may retrieve input variable data corresponding to the time that the fault occurred.

At block 106, the device control system 48 may identify correlations between one or more of the input variables and the one or more faults experienced by the industrial automation equipment. For example, in certain embodiments, the device control system 48 may identify that an input variable corresponding to a rotational speed of a motor (e.g., industrial automation device 20) has an identifiable correlation with an occurrence of a fault associated with the industrial automation equipment 50. That is, the device control system 48 may determine that as the rotational speed of the motor increases beyond a threshold rotational speed, a fault is likely to occur. In other embodiments, the device control system 48 may determine that as the rotational speed of the motor decrease below a different threshold rotational speed, a fault is likely to occur. In some cases, the device control system 48 may determine that one or more input variables in combination correlate with a fault occurring with the industrial automation equipment 50.

At block 108, the device control system 48 may determine weights for each input variable received by the device control system 48 based on the previously identified correlations. For example, the device control system 48 may assign a weight to each input variable of the multiple input variables corresponding to the operation of the industrial automation device 20 of the industrial automation equipment 50. That is, the assigned weight may correspond to a numerical value assigned to an input variable that indicates a degree of correlation between data observed in a dataset of the input variable to a particular output condition (e.g., normal operation, fault, etc.). In some embodiments, the numerical value may be a number between 0 and 1, with a number closer to 0 indicating that the data in the particular dataset of the particular input variable is less likely to be closely linked to the particular output condition. Additionally or alternatively, a numerical value closer to 1 may indicate that the data in the particular dataset of the particular input variable is more likely to be closely linked to the particular output condition. In other embodiments, an exponential, logarithmic, power series, non-linear, or otherwise appropriate numerical value scale is used to indicate a weight associated with the particular input variable.

At block 110, the device control system 48 may identify a root cause for the fault based on the weighted input variables. For example, the device control system 48 may determine that an input variable with a larger assigned weight may have caused a particular fault experienced by the industrial automation equipment 50. To continue with the example above, the device control system 48 may determine that the rotational speed of the motor exceeding the threshold rotational speed was the root cause of the particular fault of the industrial automation equipment 50. In certain embodiments, the weights determined in block 108 may be adjusted based on user input related to the determination of the root cause of the fault. For example, if the device control system 48 receives user input indicative of an additional input variable (e.g., temperature of a motor, speed of a conveyer, pressure for a hydraulic fluid line, etc.) that caused the fault, the device control system 48 may dynamically adjust the assigned weights to increase an associated weight for the additional input variable. In other embodiments, the device control system 48 may reduce the assigned weight associated with the rotational speed of the motor, and in some embodiments, the device control system 48 may not adjust the previously assigned weights associated with the input variables. In some embodiments, as additional input variables are collected over time, the weights may also be updated based on the associated correlations.

At block 112, the device control system 48 may generate a model for a root cause analysis of a fault condition of the industrial automation equipment 50 based on the correlations, the assigned weights, and the identified root cause as discussed previously in blocks 106-110. In some embodiments, the model may be dynamically updated based on received input variable datasets, new correlations identified between the received input variable datasets and a fault occurrence, and/or determinations of root causes of a fault based on a previously un-weighted input variable. In certain embodiments, the device control system 48 may employ the model to identify a root cause of a fault in response to the industrial automation equipment 50 experiencing a fault. That is, the device control system 48 may utilize the model to efficiently identify the root cause of a particular fault experienced with the industrial automation equipment 50, based on the historical data, identified correlations, weights, and root causes used to generate the model.

At block 114, the device control system 48 may store the model in a memory 76 and/or storage 78 of the device control system 48. That is, the device control system 48 may retrieve the model when a fault occurs and employ the model so that the model may facilitate a determination of a root cause of the fault. Over time, the device control system 48 may generate and store different models for different faults that have been detected or experienced by the industrial automation equipment 50. As such, the device control system 48 may retain a library of models for identifying root causes of various faults for various types of equipment.

At block 116, the device control system 48 may adjust data acquisition parameters for particular industrial automation devices 20 associated with the industrial automation equipment 50 based on the identified root cause. For example, if the model determines that the rotational speed of the motor has a large weight value (above a threshold weight value) assigned to this particular input variable, the device control system 48 may increase a sample rate or increase an amount of data to store that corresponds to this particular input variable data set. In this way, the device control system 48 may gather and store more data that is determined to be more closely correlated with faults of industrial automation equipment 50. Conversely, if the model determines that an additional input variable has a lesser weight value (below a threshold weight value), then the device control system 48 may adjust the data acquisition parameters to decrease a sample rate or decrease an amount of data to store corresponding to the additional input variable. By virtue of this adjustment, the device control system 48 may store relatively more data that is more relevant regarding the operation of the industrial automation equipment 50, improving the efficiency and capability of the device control system 48 and local control system 42 to quickly and accurately identify the root cause of a fault occurrence within the industrial automation system 10 by capturing datasets that may be more closely correlated to a respective fault.

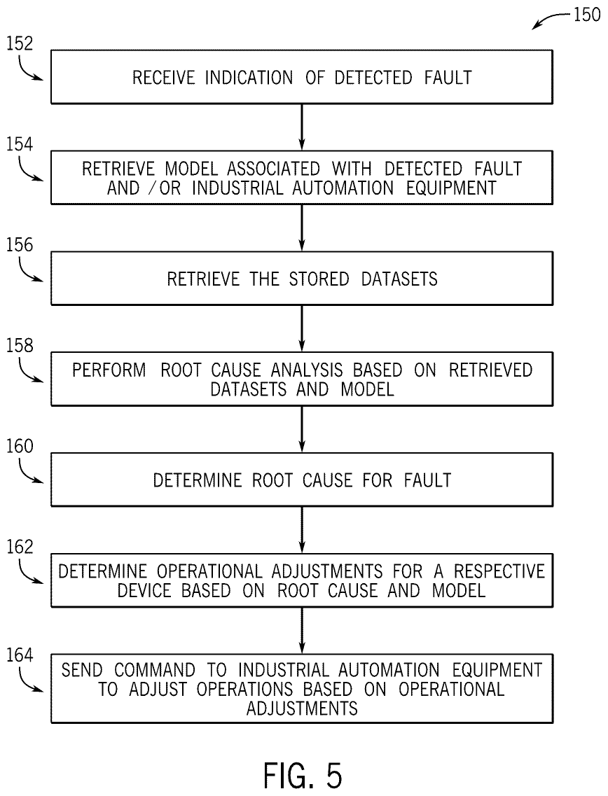

FIG. 5 illustrates an embodiment of a flow chart of a process 150 for determining a root cause of a fault experienced within the industrial automation system 10. Although the following description of the process 150 will be described as being performed by the device control system 48, it should be noted that any suitable processor-based device (e.g., the edge computing device 58, the local control system 42, etc.) may be specially programmed to perform any of the processes described herein. Moreover, although the following description of the process 150 is described as including certain steps performed in a particular order, it should be understood that the steps of the process 150 may be performed in any suitable order, that certain steps may be omitted, that certain steps may be added, and/or that certain steps may be performed simultaneously.

At block 152, the device control system 48 may receive an indication of a detected fault with a particular industrial automation equipment 50. In some embodiments, the fault may be associated with one or more of the industrial automation devices 20 that control various operations for a particular industrial automation equipment 50. That is, the device control system 48 may receive multiple output variable signals from one or more sensors 16 that correspond with various operational outputs of the industrial automation equipment 50. For example, when the industrial automation equipment 50 experiences a fault, the equipment may operate less efficiently, stop operating, or change its operations. In some cases, when the industrial automation equipment 50 experiences a fault, the device control system 48 may receive associated information relating to the fault. For example, the device control system 48 may receive a time that the fault occurred.

At block 154, the device control system 48 may retrieve a model associated with the detected fault and/or the industrial automation equipment 50. That is, the device control system 48 may store a model associated with a particular type of fault in the memory 76 and/or storage of the device control system 48 and may store an additional model associated with an additional type of fault in the memory 76 and/or storage of the device control system 48. Additionally or alternatively, the device control system 48 may store a model that generally relates to the operations of a particular piece of industrial automation equipment 50 within the industrial automation system 10. In this case, in response to the particular piece of industrial automation equipment 50 experiencing a fault, the device control system 48 may retrieve the model that is associated with the experienced fault.

At block 156, the device control system 48 may retrieve one or more stored datasets associated with the fault. For example, the device control system 48 may retrieve the datasets that correspond to the input variables that are associated with the particular piece of faulting industrial automation equipment 50. In some embodiments, the device control system 48 may retrieve the datasets from the input variables with the greatest assigned weights, as these datasets are likely to include data more relevant and closely tied to the occurrence of the fault.

At block 158, the device control system 48 may perform a root cause analysis based on the retrieved datasets and the retrieved model. For example, the device control system 48 may query the model corresponding to the particular fault and the industrial automation equipment 50 to identify a potential root cause. In some embodiments, the model may utilized the retrieved datasets to enable the model to determine a root cause of the fault. That is, the model may make a preliminary determination that the fault was likely caused by a rotational speed of a motor exceeding a rotational speed threshold. To verify this, the model may receive the one or more datasets and examine the dataset corresponding to the rotational speed of the motor in a time period leading up to the experienced fault.

At block 160, the device control system 48 may determine the root cause of the fault based on the model and the retrieved datasets. To continue with the example presented above, the model may determine that the rotational speed of the motor did in fact exceed the threshold rotational speed in a time period preceding the occurrence of the fault. However, in other embodiments, the root cause of the fault may be related to an input variable different from the input variable identified in the preliminary determination by the model. In some cases, the device control system 48 may utilize machine learning circuitry to facilitate the analysis of the retrieved model and the retrieved datasets to aid in the determination of the root cause of the fault. In addition, if the preliminary determination by the model does not correspond with the retrieved datasets, the device control system 48 may generate an update model based on the retrieved datasets any correlations identified within the datasets with respect to the fault.

At block 162, the device control system 48 may determine operational adjustments for a respective industrial automation device 20 based on the determined root cause and the model. For example, if the rotational speed of the motor was determined to be the root cause of the fault, the device control system 48 may determine that reducing the rotational speed may reduce future faults. That is, the device control system 48 may determine that the rotational speed of the motor staying below the threshold rotational speed may improve operations for the industrial automation system 10.

At block 164, the device control system 48 may send a command to the industrial automation equipment 50 to adjust operations based on the operational adjustments determined in block 162. In this way, the device control system 48 may utilize the process 150 to more efficiently identify a root cause for a fault in the industrial automation system 10, and output commands to adjust operational parameters for identified industrial automation devices 20 to adjust their operations in a manner conducive to reducing faults.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An industrial automation system comprising:
one or more industrial automation devices; and
a control system, wherein the control system comprises:
processing circuitry; and
a memory configured to store instructions that, when executed by the processing circuitry, cause the processing circuitry to:
receive a plurality of input variables associated with one or more operations of the one or more industrial automation devices over a period of time;
receive fault data corresponding to the one or more industrial automation devices;
identify at least one correlation between at least one input variable of the plurality of input variables and the fault data;
determine at least one weight for the at least one input variable based on the at least one correlation;
generate a model for identifying a root cause of a fault based on the plurality of input variables, the fault data, and the at least one weight; and
adjust at least one data acquisition parameter for at least one sensor configured to acquire at least one dataset associated with at least a second one of the plurality of input variables.

2. The industrial automation system of claim 1, wherein the instructions cause the processing circuitry to:
receive an additional plurality of input variables associated with the one or more operations of the one or more industrial automation devices over an additional period of time;
receive an indication of an additional fault;
retrieve the model in response to receiving the indication; and
identify an additional root cause of the additional fault based on the model.

3. The industrial automation system of claim 1, wherein the at least one data acquisition parameter comprises a data acquisition frequency.

4. The industrial automation system of claim 1, wherein the at least one weight comprises a value between 0 and 1.

5. The industrial automation system of claim 1, wherein the control system comprises a human machine interface (HMI) configured to receive an input directly from an operator.

6. The industrial automation system of claim 1, wherein the one or more industrial automation devices are communicatively coupled to industrial automation equipment, and wherein the industrial automation equipment comprises a mixer, a depositor, a conveyor, an oven, or a combination thereof.

7. The industrial automation system of claim 1, wherein the instructions cause the processing circuitry to:
receive an input indicative of an additional input variable associated with the root cause;
update at least one weight for the at least one input variable based on the input; and
update the model based on the at least one weight.

8. A method, comprising:
receiving, via one or more processors of a control system, a plurality of input variables associated with one or more operations of one or more industrial automation devices over a period of time;
receiving, via the one or more processors, fault data corresponding to the one or more industrial automation devices;
identifying, via the one or more processors, at least one correlation between at least one input variable of the plurality of input variables and the fault data;
determining, via the one or more processors, at least one weight for the at least one input variable based on the at least one correlation;
generating, via the one or more processors, a model for identifying a root cause of a fault based on the plurality of input variables, the fault data, and the at least one weight; and
adjusting, via the one or more processors, at least one data acquisition parameter for at least one sensor configured to acquire at least one dataset associated with at least a second one of the plurality of input variables.

9. The method of claim 8, comprising:
receiving, via the one or more processors, an additional plurality of input variables associated with the one or more operations of the one or more industrial automation devices over an additional period of time;
receiving, via the one or more processors, an indication of an additional fault;
retrieving, via the one or more processors, the model in response to receiving the indication; and
identifying, via the one or more processors, an additional root cause of the additional fault based on the model.

10. The method of claim 8, wherein the at least one data acquisition parameter comprises a data acquisition frequency.

11. The method of claim 8, wherein the at least one weight comprises a value between 0 and 1.

12. The method of claim 8, wherein the control system comprises a human machine interface (HMI) configured to receive an input directly from an operator.

13. The method of claim 8, wherein the one or more industrial automation devices are communicatively coupled to industrial automation equipment, and wherein the industrial automation equipment comprises a mixer, a depositor, a conveyor, an oven, or a combination thereof.

14. The method of claim 8, comprising:
receiving an input indicative of an additional input variable associated with the root cause;
updating at least one weight for the at least one input variable based on the input; and
updating the model based on the at least one weight.

15. A local control system of an industrial automation system comprising:
a human machine interface (HMI);
one or more industrial automation devices; and
a device control system communicatively coupled to the HMI and the one or more industrial automation devices, wherein the device control system comprises:
processing circuitry; and
a memory configured to store instructions that, when executed by the processing circuitry, cause the processing circuitry to:
receive a plurality of input variables associated with one or more operations of the one or more industrial automation devices over a period of time;
receive fault data corresponding to the one or more industrial automation devices;
identify at least one correlation between at least one input variable of the plurality of input variables and the fault data;
determine at least one weight for the at least one input variable based on the at least one correlation;
generate a model for identifying a root cause of a fault based on the plurality of input variables, the fault data, and the at least one weight; and
adjust at least one data acquisition parameter for at least one sensor configured to acquire at least one dataset associated with at least a second one of the plurality of input variables.

16. The local control system of claim 15, wherein the instructions cause the processing circuitry to:
receive an additional plurality of input variables associated with the one or more operations of the one or more industrial automation devices over an additional period of time;
receive an indication of an additional fault;
retrieve the model in response to receiving the indication; and
identify an additional root cause of the additional fault based on the model.

17. The local control system of claim 15, wherein the at least one data acquisition parameter comprises a data acquisition frequency.

18. The local control system of claim 15, wherein the at least one weight comprises a value between 0 and 1.

19. The local control system of claim 15, wherein the one or more industrial automation devices are communicatively coupled to industrial automation equipment, and wherein the industrial automation equipment comprises a mixer, a depositor, a conveyor, an oven, or a combination thereof.

20. The local control system of claim 15, wherein the instructions cause the processing circuitry to:
receive an input indicative of an additional input variable associated with the root cause;
update at least one weight for the at least one input variable based on the input; and
update the model based on the at least one weight.
